(19) United States
(12) Patent Application Publication
(10) Pub. No.: US 2014/0375658 A1
(43) Pub. Date: Dec. 25, 2014

(54) Processor Core to Graphics Processor Task Scheduling and Execution

(71) Applicant: ATI Technologies ULC, Markham (CA)

(72) Inventors: Yury Lichmanov, Richmond Hill (CA); Serguei Sagalovitch, Richmond Hill (CA)

(73) Assignee: ATI Technologies ULC, Markham, ON (CA)

(21) Appl. No.: 13/925,880

(22) Filed: Jun. 25, 2013

(51) Int. Cl. G06T 1/20

(52) U.S. Cl. CPC G06T 1/20
USPC 345/520

(57) ABSTRACT

An apparatus and method for processor core to graphics processor scheduling and execution is disclosed. In one embodiment, an apparatus includes a general purpose processor configured to execute instructions from a first instruction set and a graphic processing unit (GPU) configured to execute instructions from a second instruction set. The apparatus also includes a microcode unit configured to store microcode instructions that, when executed by the general purpose processor core, generate translated instructions, wherein the translated instructions are generated by translating selected instructions from the first instruction set translated into instructions of the second instruction set. The general purpose processor is configured to, responsive to performing a translation, pass the translated instructions to the GPU. The GPU is configured to execute the translated instructions and pass corresponding results back to the general purpose processor.

### BACKGROUND

1. Technical Field

This disclosure relates to integrated circuits, and more particularly, to using a graphics processing unit for performing computational functions.

2. Description of the Related Art

In current practice, a modern processor may be implemented in a package that is known as a system on a chip (SoC). An SoC may include at least one general purpose processor core (and in many cases, multiple general purpose processor cores), a bridge unit (e.g., a north bridge), a microcode unit for storing microcode instructions, a memory controller, and so on. Many SoCs also include a graphics processing unit (GPU). SoCs of this type are widely deployed, including in desktop computer systems, laptop computers, tablet computers, smart phones, and other types of systems.

The general purpose processor core(s) of an SoC may perform many of the computational functions of the system. In some cases, the general purpose processor cores may be superscalar processors having execution units for different types of data (e.g., fixed point data, floating point data, integer data). A GPU on the other hand may be used for processing graphics information, and may include dozens, if not hundreds of execution units. The types of computational functions performed by a GPU may include texture mapping, rendering, translation of coordinates, and so on. Moreover, the GPU may be suited for performing parallel operations related to graphics processing due to its large number of execution units.

### SUMMARY OF EMBODIMENTS OF THE DISCLOSURE

An apparatus and method for processor core to graphics processor scheduling and execution is disclosed. In one embodiment, an apparatus includes a general purpose processor configured to execute instructions from a first instruction set and a graphic processing unit (GPU) configured to execute instructions from a second instruction set. The apparatus also includes a microcode unit configured to store microcode instructions that, when executed by the general purpose processor core, generate translated instructions, wherein the translated instructions are generated by translating selected instructions from the first instruction set translated into instructions of the second instruction set. The general purpose processor is configured to, responsive to performing a translation, pass the translated instructions to the GPU. The GPU is configured to execute the translated instructions and pass corresponding results back to the general purpose processor.

In one embodiment, a method includes translating one or more instructions from a first instruction set into corresponding instructions of a second instruction set, wherein said translating is performed by a general purpose processor core executing microcode instructions. The method further includes executing, on a graphics processing unit (GPU), the corresponding instructions of the second instruction set, and passing results of said executing from the GPU to the general purpose processor.

### BRIEF DESCRIPTION OF THE DRAWINGS

Other aspects of the disclosure will become apparent upon reading the following detailed description and upon reference to the accompanying drawings which are now described as follows.

FIG. 1 is a block diagram of one embodiment of an integrated circuit (IC) system on a chip (SoC).

FIG. 2 is a block diagram of one embodiment of a processor core.

FIG. 3 is a block diagram of one embodiment of a graphics processing unit (GPU).

FIG. 4 is a flow diagram illustrating one embodiment of a method for transferring the execution of instructions from a processor core to a GPU.

FIG. 5 is block diagram of one embodiment of a computer readable medium.

While the subject matter disclosed herein is susceptible to various modifications and alternative forms, specific embodiments thereof are shown by way of example in the drawings and will herein be described in detail. It should be understood, however, that the drawings and description thereto are not intended to be limiting to the particular form disclosed, but, on the contrary, is to cover all modifications, equivalents, and alternatives falling within the spirit and scope of the present disclosure as defined by the appended claims.

### DETAILED DESCRIPTION

### Overview:

The present disclosure is directed to a method and apparatus for executing certain instructions of a thread on a graphics processing unit (GPU) in lieu of executing the same on a general purpose processor core. Implementation may be realized with only minor changes to the circuitry of an SoC or other system in which the methodology described herein is implemented.

In one embodiment, a processor core of a processor may translate certain instructions from a first instruction set (e.g., the instruction set used by the processor core) into instructions from a second instruction set (e.g., used by the GPU). Thereafter, the translated instructions may be passed to the GPU and executed thereon. After completion of execution of the translated instructions, corresponding results may be passed back to the processor core which initiated the transfer.

The instructions to be translated may include extensions or other indications or may otherwise be part of an extended instruction set (e.g., Advanced Vector Extensions). The instructions may be part of a thread, wherein a thread may be defined herein as the smallest sequence of programmed instructions that can be managed independently by an operating system scheduler. The translation of the instructions may occur prior to or during the execution of the thread. In one embodiment, the translation may be performed by the processor core that is to execute the thread, and may involve the invoking of one or more microcode routines. A first microcode routine may be executed by a processor core to translate instructions from the first instruction (of the processor core) to the second instruction set (of the GPU). In the case where data pointers are to be passed along with the translated instructions, a second microcode routine may be invoked to translate the data pointers from a first format (suitable for use by the processor core) into a second format (suitable for use by the GPU). After completion of the translation operation(s), the translated instructions (and data pointers, if included) may be passed to the GPU for execution. After execution on the GPU is completed, results may be passed back to the processor core that was executing the thread from which the translated instructions were generated.

In some embodiments, the execution of a thread on a processor core may be suspended during the time that translated instructions therefrom are being executed on the GPU. In one embodiment, one of one or more processor cores may execute instructions of operation system software. When a given one of the processor cores passes translated instructions to the GPU, the operating system software may suspend execution of a corresponding thread (as opposed to the thread stalling in that core). During the time that the execution of the corresponding thread is suspended, a second thread may be assigned to the same processor core and executed thereon. After the GPU completes execution of the translated instructions generated from the original thread, the operating system software may halt execution of the second thread (if its execution is not complete) and resume execution of the original thread. Such suspension of operation may be performed for some threads, but not necessarily all. For example, if continued execution of the thread is dependent on data received from the GPU responsive to execution of translated instructions, then execution of the thread on its particular processor core may be suspended. However, in some embodiments (e.g., those that support out of order execution), instructions in the thread subsequent to those that are translated may be allowed to proceed concurrent with the execution of the translated instructions on the GPU.

As noted above, the translation of instructions from one instruction set to another may be performed by a processor core executing a microcode routine. Similarly, translation of data pointers from one format to another may also be performed by a processor core executing a microcode routine. A microcode routine may be defined herein as a routine that utilizes one or more microcode instructions. A microcode instruction may be defined as an instruction comprised of at least one instruction from a defined instruction set (where instructions of an instruction set may be referred to as machine-language instructions), with many microcode instructions comprising two or more instructions from that instruction set. There is no defined upper limit to the number of machine-level instructions that may be included in a microcode instruction. A microcode routine may further be defined herein as a routine that includes at least one microcode instruction that comprises two or more instructions from the machine level instruction set. For example, a processor core may implement an instruction set having a number of machine level instructions. A microcode routine executable by that processor core may include one or more microcode instructions, with at least one of the microcode instructions comprising two or more instructions from its corresponding instruction set.

Processor with Power Management Unit:

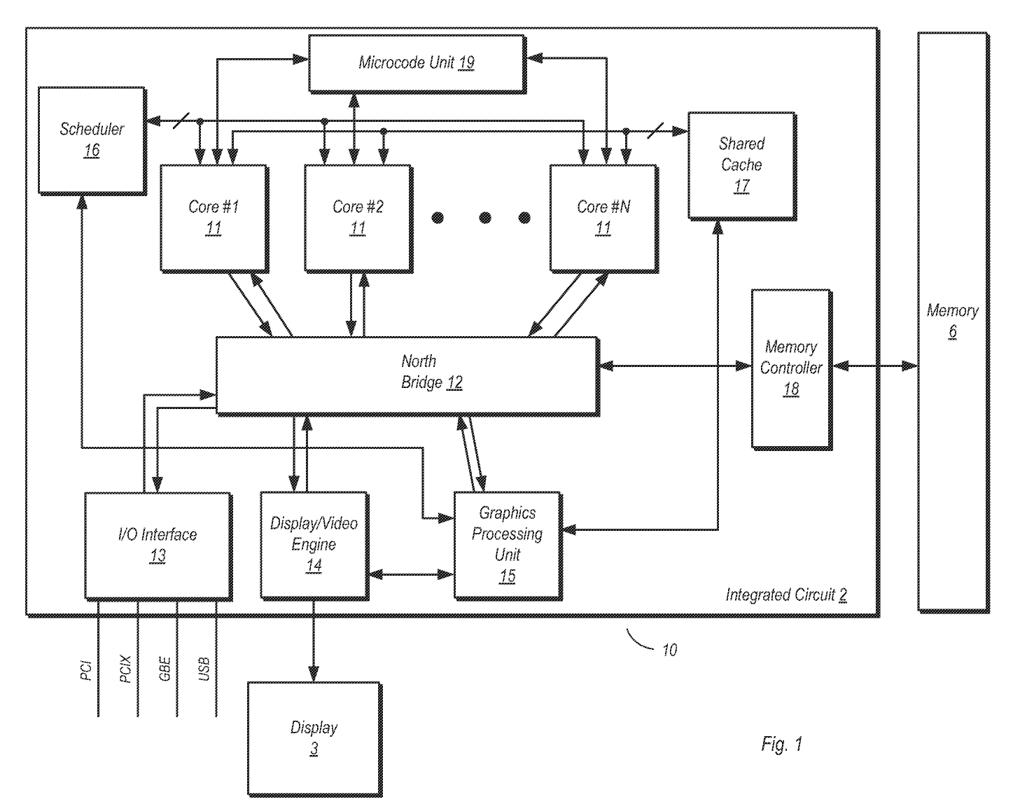

FIG. 1 is a block diagram of one embodiment of an integrated circuit (IC) coupled to a memory. IC2 and memory 6, along with display 3 and display memory 300, form at least a portion of computer system 10 in this example. In the embodiment shown, IC2 is a processor having a number of processor cores 11. Processor cores 11 are processor cores in this particular example, and are thus also designated as Core #1, Core #2, and so forth. It is noted that the methodology to be described herein may be applied to other arrangements, such as multi-processor computer systems implementing multiple processors (which may be single-core or multi-core processors) on separate, unique IC dies. Furthermore, embodiments having only a single processor core 11 are also possible and contemplated.

Each processor core 11 is coupled to north bridge 12 in the embodiment shown. North bridge 12 may provide a wide variety of interface functions for each of processor cores 11, including interfaces to memory 6, various peripherals. Additionally, north bridge 12 may provide functions for enabling communications among the various processor cores 11, I/O interface 13, and so on.

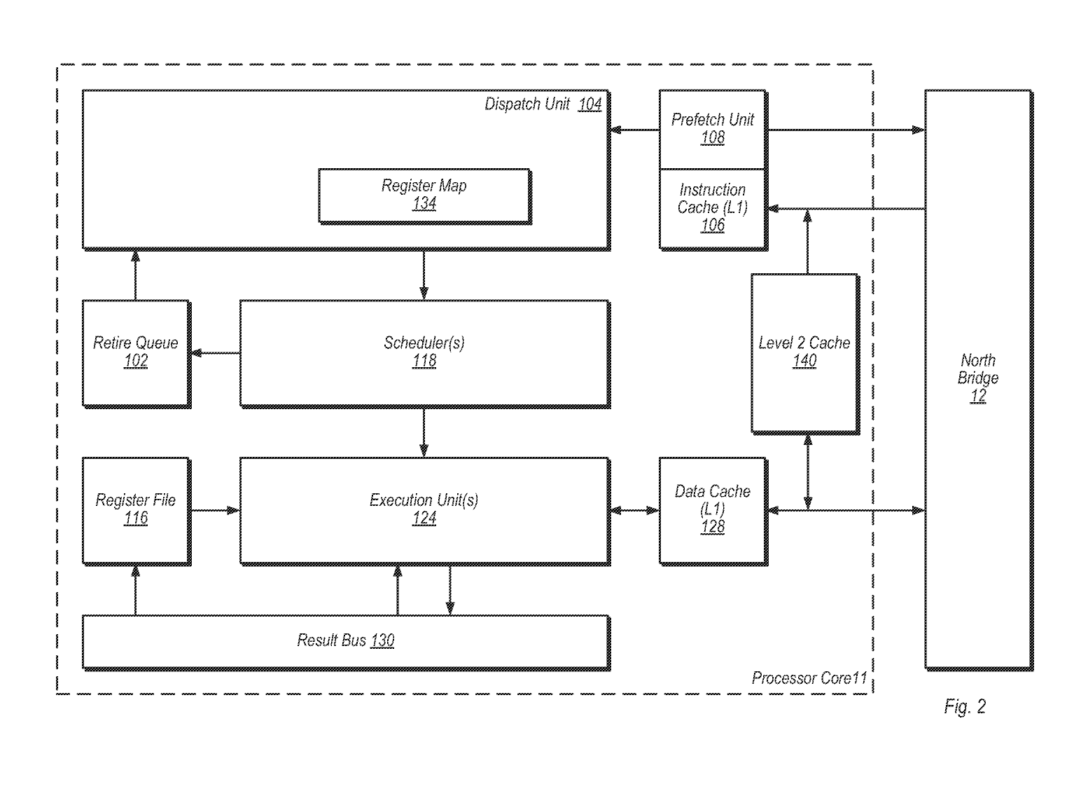

Each of the processor cores 11 in the embodiment shown may be a general purpose processor that implements a particular instruction set (e.g., the x86 instruction set and variations thereof). In various embodiments, the number of processor cores 11 may be as few as one, or may be as many as feasible for implementation on an IC die. Processor cores 11 may each include one or more execution units. In one embodiment, each of the processor cores 11 may be a superscalar processor, and may include a floating point unit, a fixed point unit, and an integer unit. Each of processor cores 11 may also include cache memories, schedulers, branch prediction circuits, and so forth (an exemplary processing node will be discussed below with reference to FIG. 2). Furthermore, each of processor cores 11 may be configured to assert requests for access to memory 6, which may function as the main memory for computer system 10. Such requests may include read requests and/or write requests, and may be initially received from a respective processor core 11 by north bridge 12. Requests for access to memory 6 may be routed through memory controller 18 in the embodiment shown.

I/O interface 13 is also coupled to north bridge 12 in the embodiment shown. I/O interface 13 may function as a south bridge device in computer system 10. A number of different types of peripheral buses may be coupled to I/O interface 13. In this particular example, the bus types include a peripheral component interconnect (PCI) bus, a PCI-Extended (PCI-X), a PCIE (PCI Express) bus, a gigabit Ethernet (GBE) bus, and a universal serial bus (USB). However, these bus types are exemplary, and many other bus types may also be coupled to I/O interface 13. Peripheral devices may be coupled to some or all of the peripheral buses. Such peripheral devices include (but are not limited to) keyboards, mice, printers, scanners, joysticks or other types of game controllers, media recording devices, external storage devices, network interface cards, and so forth. At least some of the peripheral devices that may be coupled to I/O unit 13 via a corresponding peripheral bus may assert memory access requests using direct memory access (DMA). These requests (which may include read and write requests) may be conveyed to north bridge 12 via I/O interface 13, and may be routed to memory controller 18.

In the embodiment shown, IC2 includes a display/video engine 14 that is coupled to display 3 of computer system 10. Display 3 may be a flat-panel LCD (liquid crystal display), plasma display, a CRT (cathode ray tube), or any other suitable display type. Display/video engine 14 may output processed graphics data to display 3. IC2 also includes a graphics processing unit (GPU 15). In the embodiment shown, GPU 15 is a circuit that may perform various video processing functions and provide the processed information to display 3 (via display/video engine 14) for output as visual information. Video processing functions performed by GPU 15 include (but are not limited to) 3-D processing, processing for video games, and more complex types of graphics processing.

In addition to its functions in processing graphics information, GPU 15 may also be used to process non-graphics information in the embodiment shown. As discussed below, GPU 15 may include a number of execution units, and may be suitable for performing certain tasks, including those that are highly parallel in nature. Furthermore, since GPU 15 may have a large number of execution units, it may have enough processing bandwidth to allow some execution units to be diverted to perform non-graphics processing while continuing to enable graphics processing to be performed on other execution units. The non-graphics processing performed by GPU 15 may be transferred thereto from one of processor cores 11, as is explained below.

IC2 in the embodiment shown includes a scheduler 16 that is shared by each of the processor cores 11 and GPU 15. Scheduler 15 may schedule various threads for execution on various ones of the processor cores, and may also schedule graphics processing to be performed on GPU 15. The scheduling may be performed via various scheduling channels within scheduler 16. In addition, scheduler 16 may implement at least one scheduling channel that is dedicated solely to the transfer of certain non-graphics related operations from a processor core 11 to GPU 15. This dedicated channel may ensure that the transfer of operations to GPU 15 and the return of results therefrom may be timely, particularly since such operations may have a high priority. In one embodiment, scheduler 16 may, after scheduling a particular thread to be executed on a particular processor core 11, may also provide an indication to that processor core that some of its instructions invoke operations that may be passed to GPU 15. As such, the execution of such a thread may be temporarily interrupted on a given processor core 11 while designated operations are performed by GPU 15. After GPU 15 has completed the designated operations, the execution of the thread on the processor core 11 may resume.

IC2 in the embodiment shown also includes a microcode unit 19. Microcode unit 19 may store microcode routines, each of which is made up of a number of microcode instructions. Each microcode instruction in turn may be comprised of at least one instruction from the same instruction set used by processor cores 11, although numerous microcode instructions may include two or more instructions from the instruction set used by processor cores 11. The various microcode routines stored in microcode unit 19 may include translation routines used to translate instructions from the instruction set used by the processor cores 11 into instructions of the instruction set used by GPU 15. Another microcode routine stored in microcode unit 19 may translate data pointers from a format suitable for use with one of processor cores 11 into a format suitable for use with GPU 15. The use of these routines may be invoked by extensions to certain instructions or other indications within such instructions. Thus, a processor core 11 executing a thread including such instructions may invoke the microcode routine to translate these instructions such that they are part of the same instruction set used by GPU 15, with a corresponding translation of data pointers, if necessary. At some point after the translation, the translated instructions may be passed to GPU 15 and executed thereon, with the results being passed back to the originating processor core 11.

Shared cache 17 in the embodiment shown is a cache that is shared between the processor cores 11 and GPU 15. Both instructions and data may be stored in shared cache 17. Accordingly, any of processor cores 11 and GPU 15 may access instructions or data from shared cache 17. In one embodiment, a processor core 11 may access instructions to be translated into the instruction set of GPU 15 responsive to scheduling of a particular thread to that processor core (i.e., where the scheduled thread includes instructions that would invoke the microcode routine for performing instruction translations). After the instructions have been translated from the processor core instruction set to the GPU instruction set, the translated instructions may be stored back into shared cache 17 and subsequently be access therefrom by GPU 15.

It should be noted that embodiments are possible and contemplated wherein the various units discussed above are implemented on separate IC's. For example, one embodiment is contemplated wherein cores 11 are implemented on a first IC, north bridge 12 and memory controller 18 are on another IC, while the remaining functional units are on yet another IC. In general, the functional units discussed above may be implemented on as many or as few different ICs as desired, as well as on a single IC.

### Processor Core:

FIG. 2 is a block diagram of one embodiment of a processor core 11. The processor core 11 is configured to execute instructions that may be stored in a system memory, such as memory 6. Many of these instructions operate on data that is also stored in the system memory.

In the illustrated embodiment, the processor core 11 may include a level one (L1) instruction cache 106 and an L1 data cache 128. The processor core 11 may include a prefetch unit 108 coupled to the instruction cache 106. A dispatch unit 104 may be configured to receive instructions from the instruction cache 106 and to dispatch operations to the scheduler(s) 118. One or more of the schedulers 118 may be coupled to receive dispatched operations from the dispatch unit 104 and to issue operations to the one or more execution unit(s) 124. The execution unit(s) 124 may include one or more integer units, one or more floating point units, and one or more load/store units. Results generated by the execution unit(s) 124 may be output to one or more result buses 130 (a single result bus is shown here for clarity, although multiple result buses are possible and contemplated). These results may be used as operand values for subsequently issued instructions and/or stored to the register file 116. A retire queue 102 may be coupled to the scheduler(s) 118 and the dispatch unit 104. The retire queue 102 may be configured to determine when each issued operation may be retired.

In one embodiment, the processor core 11 may be designed to be compatible with the x86 architecture (also known as the Intel Architecture-32, or IA-32). In another embodiment, the processor core 11 may be compatible with a 64-bit architecture. Embodiments of processor core 11 compatible with other architectures are contemplated as well.

Note that each of the processor cores 11 may also include many other components. For example, the processor core 11 may include a branch prediction unit (not shown) configured to predict branches in executing instruction threads.

The instruction cache 106 may store instructions for fetch by the dispatch unit 104. Instruction code may be provided to the instruction cache 106 for storage by prefetching code from the system memory 200 through the prefetch unit 108. Instruction cache 106 may be implemented in various configurations (e.g., set-associative, fully-associative, or direct-mapped).

Processor core 11 may also include a level two (L2) cache 140. Whereas instruction cache 106 may be used to store instructions and data cache 128 may be used to store data (e.g., operands), L2 cache 140 may be a unified used to store instructions and data. Although not explicitly shown here, some embodiments may also include a level three (L3) cache. In general, the number of cache levels may vary from one embodiment to the next.

The prefetch unit 108 may prefetch instruction code from the system memory 200 for storage within the instruction cache 106. The prefetch unit 108 may employ a variety of specific code prefetching techniques and algorithms.

The dispatch unit 104 may output operations executable by the execution unit(s) 124 as well as operand address information, immediate data and/or displacement data. In some embodiments, the dispatch unit 104 may include decoding circuitry (not shown) for decoding certain instructions into operations executable within the execution unit(s) 124. Simple instructions may correspond to a single operation. In some embodiments, more complex instructions may correspond to multiple operations. Upon decode of an operation that involves the update of a register, a register location within register file 116 may be reserved to store speculative register states (in an alternative embodiment, a reorder buffer may be used to store one or more speculative register states for each register and the register file 116 may store a committed register state for each register). A register map 134 may translate logical register names of source and destination operands to physical register numbers in order to facilitate register renaming. The register map 134 may track which registers within the register file 116 are currently allocated and unallocated.

The processor core 11 of FIG. 2 may support out of order execution. The retire queue 102 may keep track of the original program sequence for register read and write operations, allow for speculative instruction execution and branch misprediction recovery, and facilitate precise exceptions. In some embodiments, the retire queue 102 may also support register renaming by providing data value storage for speculative register states (e.g. similar to a reorder buffer). In other embodiments, the retire queue 102 may function similarly to a reorder buffer but may not provide any data value storage. As operations are retired, the retire queue 102 may deallocate registers in the register file 116 that are no longer needed to store speculative register states and provide signals to the register map 134 indicating which registers are currently free. By maintaining speculative register states within the register file 116 (or, in alternative embodiments, within a reorder buffer) until the operations that generated those states are validated, the results of speculatively-executed operations along a mispredicted path may be invalidated in the register file 116 if a branch prediction is incorrect.

In one embodiment, a given register of register file 116 may be configured to store a data result of an executed instruction and may also store one or more flag bits that may be updated by the executed instruction. Flag bits may convey various types of information that may be important in executing subsequent instructions (e.g. indicating a carry or overflow situation exists as a result of an addition or multiplication operation. Architecturally, a flags register may be defined that stores the flags. Thus, a write to the given register may update both a logical register and the flags register. It should be noted that not all instructions may update the one or more flags.

The register map 134 may assign a physical register to a particular logical register (e.g. architected register or microarchitecturally specified registers) specified as a destination operand for an operation. The dispatch unit 104 may determine that the register file 116 has a previously allocated physical register assigned to a logical register specified as a source operand in a given operation. The register map 134 may provide a tag for the physical register most recently assigned to that logical register. This tag may be used to access the operand's data value in the register file 116 or to receive the data value via result forwarding on the result bus 130. If the operand corresponds to a memory location, the operand value may be provided on the result bus (for result forwarding and/or storage in the register file 116) through a load/store unit (not shown). Operand data values may be provided to the execution unit(s) 124 when the operation is issued by one of the scheduler(s) 118. Note that in alternative embodiments, operand values may be provided to a corresponding scheduler 118 when an operation is dispatched (instead of being provided to a corresponding execution unit 124 when the operation is issued).

As used herein, a scheduler is a device that detects when operations are ready for execution and issues ready operations to one or more execution units. For example, a reservation station may be one type of scheduler. Independent reservation stations per execution unit may be provided, or a central reservation station from which operations are issued may be provided. In other embodiments, a central scheduler which retains the operations until retirement may be used. Each scheduler 118 may be capable of holding operation information (e.g., the operation as well as operand values, operand tags, and/or immediate data) for several pending operations awaiting issue to an execution unit 124. In some embodiments, each scheduler 118 may not provide operand value storage. Instead, each scheduler may monitor issued operations and results available in the register file 116 in order to determine when operand values will be available to be read by the execution unit(s) 124 (from the register file 116 or the result bus 130). As noted above, in reference to FIG. 1, a multi-core processor may include a single scheduler (scheduler 16) that perform scheduling for all processor cores 11 as well as for GPU 15. Alternatively, the scheduler(s) 118 shown in FIG. 2 may be part of distributed scheduling function that is otherwise provided by scheduler 16. In such embodiments, scheduler(s) 118 in each of processor cores 11 may implement the dedicated channel that is used with the transfer of some operations from a processor core 11 to GPU 15 during the execution of some threads.

### Graphics Processing Unit:

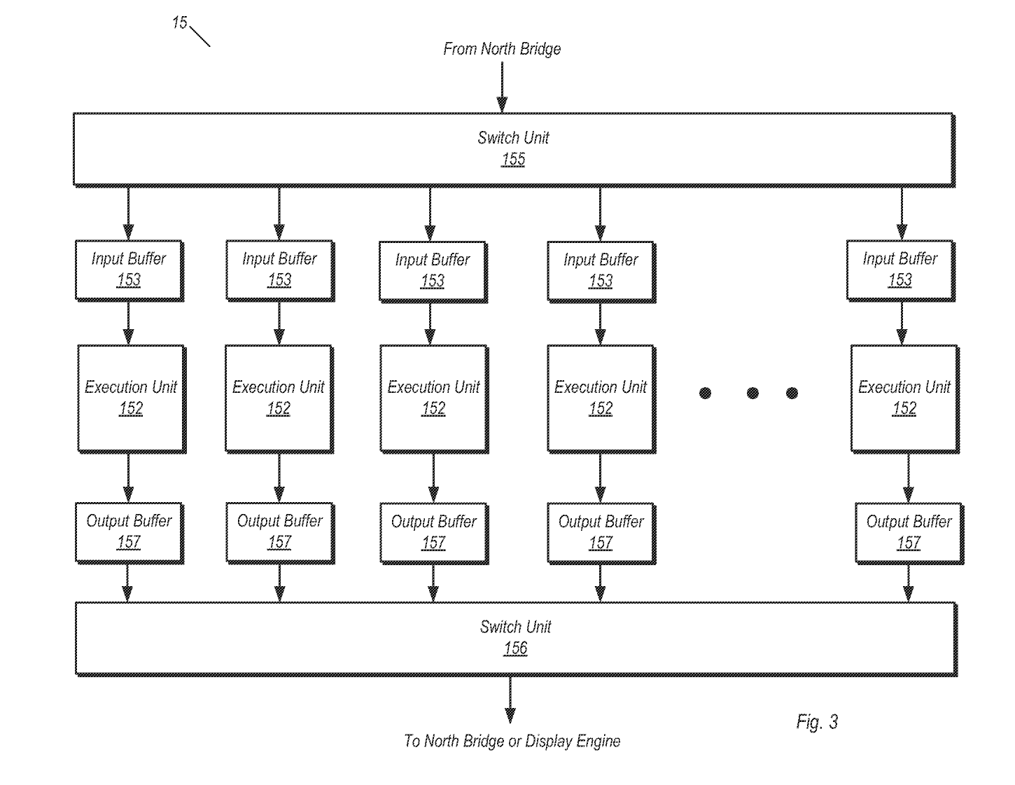

Turning now to FIG. 3, a simplified block diagram of one embodiment of a graphics processing unit. In the embodiment shown, GPU 15 includes a number of execution units 152. The particular number of execution units 152 may vary from one embodiment to the next. There is no predefined upper limit to the number of execution units 152 that may be present in any one particular embodiment. Furthermore, embodiments in which the number of execution units 152 is more than one hundred are possible and contemplated. The execution units 152 may operate in parallel with one another.

Generally speaking, in embodiments of GPU 15 having a large number of execution units 152, the total available processing bandwidth may be high enough to permit the diversion of at least some execution units 152 to the performance of tasks that are not related to graphics processing. Two such examples, as noted above, are vector multiplication and matrix operations (e.g., the multiplication of matrices). Such operations may exploit the high level of parallelism that may be obtained in the structure of GPU 15 in the embodiment shown. Moreover, because of this parallelism, GPU 15 may be more suitable than any of processor cores 11 for performing operations such as the previously mentioned vector and matrix operations. That is, GPU 15 may perform/execute highly parallel operations more quickly and efficiently than any of processor cores 11.

It is noted that while specific types of operations are mentioned in the previous paragraph, the transfer of operations from a processor core 11 to GPU 15 as discussed herein is not limited to these types. In general, any type of operation that may be more efficiently executed by GPU 15 may be transferred thereto from a processor core 11. This includes any type of operation for which the degree of parallelism makes the structure of GPU 15 more suitable than processor core 11 for fast and efficient processing.

Each of the execution units 152 in the embodiment shown is configured to execute instructions of a given instruction set. The instruction set used by the execution units 152 in the embodiment shown may be different than the instruction set utilized by processor cores 11. Accordingly, operations that are transferred from a processor core 11 to selected execution units 152 are first translated into instructions of GPU 15's instruction set. Some instructions to be executed may also require data pointers. Thus, the data pointers may also be translated into a format usable by GPU 15 prior to being passed thereto.

In the embodiment shown, GPU 15 includes a switch unit 155 coupled to receive information from north bridge 12. Information that may be received from north bridge 12 includes translated instructions and data pointers, along with data, and other information that may be used for graphics processing. Switch unit 155 may route the received information to selected execution units 152, via corresponding input buffers 153. Moreover, switch unit 155 may perform allocations functions in order to determine which of the execution units are to receive particular sets of received information. Thus, switch unit 155 may allocate some execution units 152 for performing graphics processing, while allocating others to perform non-graphics functions.

As noted above, the information may be received from switch unit 155 by corresponding input buffers 153. Each of the execution units 152 is associated with a unique one of input buffers 153. The input buffers may store instructions to be executed, operands to be used during the execution of instructions, data pointers used to access data during the execution of instructions, and so forth.

GPU 15 also includes a number of output buffers 157, each of which is coupled to a corresponding unique one of execution units 152. Each output buffer 157 may store results from the execution of instructions by its corresponding execution unit. The results stored in each buffer 157 may be passed to a second switch unit 156. The second switch unit 157 may route the results either to display/video engine 14 (in the case of graphics information to be displayed) or to north bridge 12 (in the case of non-graphics information).

It is noted that the arrangement of GPU 15 shown here is exemplary, and is thus not intended to be limiting. In contrast, a wide variety of different GPU types may be implemented on IC2 and may be used to perform the execution of non-graphics instructions as discussed herein.

### Method Flow:

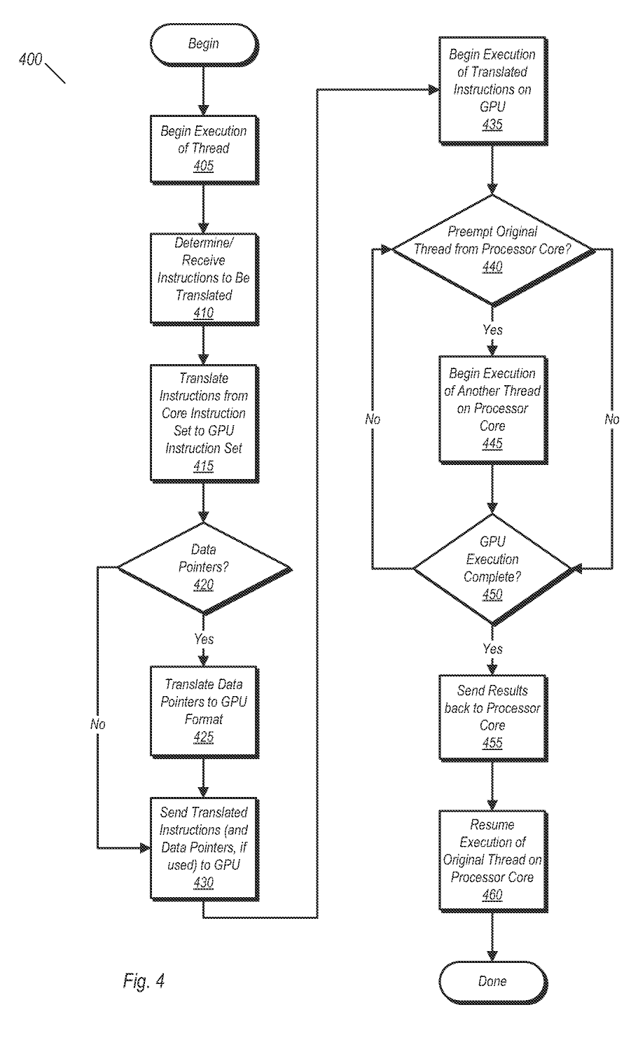

FIG. 4 illustrates on embodiment of a method for transferring the execution of instructions from a processor core to a GPU. Method 400 as shown in FIG. 4 may be performed by any of the hardware embodiments discussed above along with various embodiments of the software/firmware also discussed. Moreover, method 400 as shown in FIG. 4 may be performed other hardware and/or software embodiments not explicitly discussed herein. For example, method 400 may be performed in a system having one or more discrete central processing units (CPUs) and a discrete GPU (i.e., wherein the CPU and GPU are implemented on separate IC's). Furthermore, while method 400 illustrates events happening in a certain sequence, the performance of the method is not necessarily limited to the sequence shown. On the contrary, the sequence of some events shown in method 400 may be re-arranged and while still falling within the scope of the method that is actually shown in FIG. 4 and discussed below.

Method 400 starts with the beginning of execution of a thread on a processor core (block 405). During execution of the thread, instructions the presence of instructions therein that are to be translated for execution on a GPU may be determined (block 410). Such instructions may be those that initiate or execute operations having a high degree of parallelism. As noted above, vector operations and matrix operations are two types of operations that may be more efficiently executed by a GPU rather than by a general purpose processor core such as the superscalar processor cores 11 discussed above. Moreover, GPU 15 may be particularly suited for single instruction, multiple data (SIMD) operations. The instructions to be translated may include an indication, and extension, or may be a certain type of instruction that automatically invokes their translation.

The designated instructions may be translated from being instructions of a first instruction set (e.g., that of a processor core) to being instructions of a second instruction set (e.g., that of a GPU) (block 415). If data pointers are used in the execution of the translated instructions (block 420, yes), then the data pointers may be translated from a format suitable for the processor core to a format suitable for the GPU (block 425). Otherwise (block 420, no), the method proceeds to block 430, as it does in after the translation of the data pointers in block 425. In block 430, the translated instructions, and data pointers if included, are transferred to the GPU.

After the translated instructions are received, the execution thereof by the GPU may commence (block 435). As the translated instructions are executed on the GPU, the thread from which their un-translated counterparts originated may be suspended on the processor core upon which the thread was being executed (block 440, yes). In one embodiment, this decision may be made by operating system software executing on at least one of one or more processor cores. When the original thread is preempted, a second thread may begin execution on the same processor core (block 445). If the thread is not suspended from the original processor core (block 440, yes), In either case, the original thread from which the translated instructions originated may either be stalled on the original processor core or preempted by the execution of another thread as long as GPU execution of the translated instructions has not completed (block 450, no).

When the execution of the translated instructions is complete (block 450, yes), the GPU may send results back to the original processor core (block 455). Thereafter, execution of the original thread may resume (block 460), and any other thread that was executing during the time the GPU executed the translated instructions may be suspended or re-assigned to another processor core for completion.

### Computer Accessible Storage Medium:

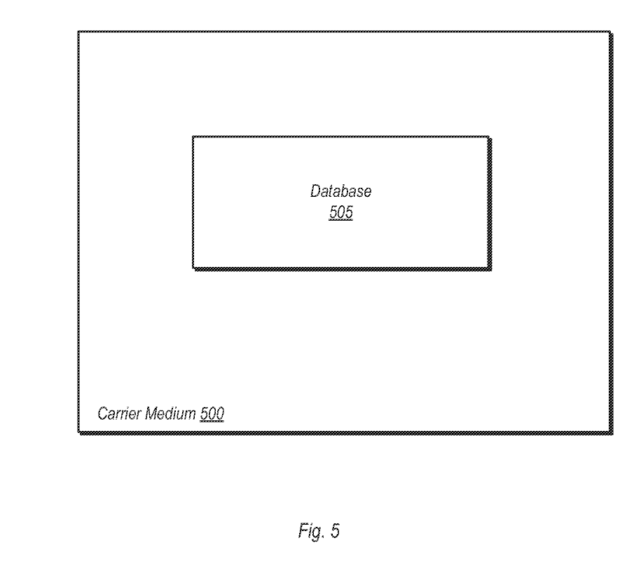

Turning next to FIG. 5, a block diagram of a computer accessible storage medium 500 including a database 505 representative of the system 10 is shown. Generally speaking, a computer accessible storage medium 500 may include any non-transitory storage media accessible by a computer during use to provide instructions and/or data to the computer. For example, a computer accessible storage medium 500 may include storage media such as magnetic or optical media, e.g., disk (fixed or removable), tape, CD-ROM, or DVD-ROM, CD-R, CD-RW, DVD-R, DVD-RW, or Blu-Ray. Storage media may further include volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media may include microelectromechanical systems (MEMS), as well as storage media accessible via a communication medium such as a network and/or a wireless link.

Generally, the database 505 of the system 10 carried on the computer accessible storage medium 500 may be a database or other data structure which can be read by a program and used, directly or indirectly, to fabricate the hardware comprising the system 10. For example, the database 505 may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates from a synthesis library. The netlist comprises a set of gates which also represent the functionality of the hardware comprising the system 10. The netlist may then be placed and routed to produce a data set describing geometric shapes to be applied to masks, using IC layout data e.g., data in Graphics Data System (GDS) II format, which may also be included in database 505. The masks may then be used in various semiconductor fabrication steps to produce a semiconductor circuit or circuits corresponding to the system 10. Alternatively, the database 505 on the computer accessible storage medium 500 may be the netlist (with or without the synthesis library) or the data set, as desired.

While the computer accessible storage medium 500 carries a representation of the system 10, other embodiments may carry a representation of any portion of the system 10, as desired, including IC2, any set of agents (e.g., processor cores 11, I/O interface 13, etc.) or portions of agents (e.g., execution units 124 of processor core 11, execution units 152 of GPU 15, etc.).

In another embodiment, database 505 stored on computer accessible storage medium 500 my include instructions that, when executed by at least one processor of a computer system, that may perform at least part of the various method embodiments described above. For example, instructions stored in database 500 may be executed by a processor on a computer system to perform some or all of the steps of method 400 described in FIG. 4.

Numerous variations and modifications will become apparent to those skilled in the art once the above disclosure is fully appreciated. It is intended that the following claims be interpreted to embrace all such variations and modifications.

What is claimed is:

1. A system comprising:
a general purpose processor configured to execute instructions from a first instruction set;
a graphic processing unit (GPU) configured to execute instructions from a second instruction set; and
a microcode unit configured to store microcode instructions that, when executed by the general purpose processor core, generate translated instructions, to wherein the translated instructions are generated by translating selected instructions from the first instruction set translated into instructions of the second instruction set;
wherein the general purpose processor is configured to, responsive to performing a translation, pass the translated instructions to the GPU; and
wherein the GPU is configured to execute the translated instructions and pass corresponding results back to the general purpose processor.

2. The system recited in claim 1, wherein the system further includes a scheduler having a plurality of scheduling channels, wherein at least one scheduling channel is dedicated to scheduling the translated instructions.

3. The system as recited in claim 1, wherein the plurality of microcode instructions each include at least one instruction from the first instruction set, and wherein the microcode instructions further include at least one microcode instruction comprising two or more instructions from the first instruction set.

4. The system as recited in claim 1, wherein the general purpose processor is configured to execute instructions from operating system software, and wherein the general purpose processor is further configured to execute instructions in threads, wherein the selected instructions are part of a first thread.

5. The system as recited in claim 4, wherein the operating system software is configured to halt execution of instructions of the first thread on the general purpose processor responsive to the general-purpose processor passing the translated instructions to the GPU.

6. The system as recited in claim 5, wherein the operating system software is configured to cause the general purpose processor to resume executing instructions of the first thread responsive to the GPU passing corresponding results back to the general purpose processor.

7. The system as recited in claim 6, wherein the operating system software is configured to cause the general purpose processor to execute instructions of a second thread subsequent to halting execution of instructions of the first thread and prior to the general purpose processor resuming execution of instructions of the first thread.

8. The system as recited in claim 1, wherein the general purpose processor is further configured to execute microcode instructions to translate data pointers from a first format specific to the general purpose processor to a second format specific to the GPU, wherein the GPU is configured to use data pointers of the second format to obtain data used in execution of instructions of the second instruction set.

9. The system as recited in claim 1, further comprising an instruction cache shared by the general purpose processor and the GPU, wherein the general purpose processor is configured to read instructions to be translated from the instruction cache and further configured to store translated instructions into the instruction cache, and wherein the GPU is configured to read translated instructions from the instruction cache.

10. The system as recited in claim 1, wherein the GPU includes a plurality of execution units, and wherein the GPU is configured to execute, in parallel, the translated instructions on a subset of the plurality of execution units.

11. A method comprising:
translating one or more instructions from a first instruction set into corresponding instructions of a second instruction set, wherein said translating is performed by a general purpose processor core executing microcode instructions;
executing, on a graphics processing unit (GPU), the corresponding instructions of the second instruction set; and
passing results of said executing from the GPU to the general purpose processor.

12. The method as recited in claim 11, further comprising scheduling execution of the corresponding instructions in a dedicated scheduling channel.

13. The method as recited in claim 11, wherein the plurality of microcode instructions each include at least one instruction from the first instruction set, and wherein the microcode instructions further include at least one microcode instruction comprising two or more instructions from the first instruction set.

14. The method as recited in claim 11, further comprising:
executing, on the general purpose processor, instructions of a first thread, wherein the instructions of the first thread include the one or more instructions of the first instruction set to be translated into instructions of the second instruction set; and
executing, on the general purpose processor, instructions from operating system software.

15. The method as recited in claim 14, further comprising suspending execution of instructions of the first thread on the general purpose processor responsive to the general purpose processor passing the corresponding instructions of the second instruction set to the GPU.

16. The method as recited in claim 15, further comprising resuming execution of instructions of the first thread responsive to the GPU passing, to the general purpose processor, results generated from executing the corresponding instructions.

17. The method as recited in claim 16, further comprising the operating system software causing the general purpose processor to execute instructions of a second thread subsequent to suspending execution of instructions of the first thread and prior to the general purpose processor resuming execution of instructions of the first thread.

18. The method as recited in claim 11, further comprising:
the general purpose processor executing microcode instructions to translate data pointers from a first format specific to the general purpose processor to a second format specific to the GPU; and
the GPU using data pointers of the second format to obtain data used in execution of the corresponding instructions of the second instruction set.

19. The method as recited in claim 11, further comprising:
reading, using the general purpose processor, instructions to be translated from the first instruction set to the second instruction set from a shared instruction cache;
storing, using the general purpose processor, the corresponding instructions of the second instruction set into the shared instruction cache; and
reading, using the GPU, the corresponding instructions of the instruction set from the shared instruction set.

20. The method as recited in claim 11, wherein the GPU includes a plurality of execution units, and wherein the method further comprises the GPU executing, in parallel, the translated instructions on a subset of the plurality of execution units.

21. A non-transitory computer readable medium storing a data structure which is operated upon by a program executable on a computer system, the program operating on the data structure to perform a portion of a process to fabricate an integrated circuit including circuitry described by the data structure, the circuitry described in the data structure including:
a general purpose processor configured to execute instructions from a first instruction set;
a graphic processing unit (GPU) configured to execute instructions from a second instruction set; and
a microcode unit storing microcode instructions that, when executed by the general purpose processor core, generate translated instructions, wherein the translated instructions are generated by translating selected instructions from the first instruction set translated into instructions of the second instruction set;
wherein the general purpose processor is configured to, responsive to performing a translation, pass the translated instructions to the GPU; and
wherein the GPU is configured to executed the translated instructions and pass corresponding results back to the general purpose processor.
